(19) United States
(12) Patent Application Publication
(10) Pub. No.: US 2026/0230243 A1
(43) Pub. Date: Aug. 6, 2026

(54) WAVEFORM AND MODULATION CONFIGURATION FOR TRANSMISSIONS

(71) Applicant: QUALCOMM Incorporated, San Diego, CA (US)

(72) Inventors: Ahmed ELSHAFIE, San Diego, CA (US); Zhikun WU, Beijing (CN); Wei YANG, San Diego, CA (US); Seyedkianoush HOSSEINI, San Diego, CA (US); Huilin XU, Temecula, CA (US); Linhai HE, San Diego, CA (US); Yuchul KIM, San Diego, CA (US); Wanshi CHEN, San Diego, CA (US)

(21) Appl. No.: 19/147,880

(22) PCT Filed: Mar. 1, 2023
(86) PCT No.: PCT/CN2023/078922

§ 371 Date: Jul. 14, 2025

(51) Int. Cl. H04L 5/00; H04L 1/00; H04L 27/00

(52) U.S. Cl. CPC H04L 5/001; H04L 1/0004; H04L 1/0023; H04L 5/0048; H04L 5/0091; H04L 27/0008; H04L 27/0012

(57) ABSTRACT

Various aspects of the present disclosure generally relate to wireless communication. In some aspects, a user equipment (UE) may receive a configuration defining an event that triggers an event-based switch, the configuration further defining one or more of a waveform, a modulation, or a channel coding associated with the event-based switch. The UE may perform, based at least in part on an occurrence of the event, a transmission using one or more of the waveform, the modulation, or the channel coding. Numerous other aspects are described.

### FIELD OF THE DISCLOSURE

Aspects of the present disclosure generally relate to wireless communication and to techniques and apparatuses for a waveform and modulation configuration for transmissions.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, a user equipment (UE) for wireless communication includes a memory and one or more processors coupled with the memory and configured to cause the UE to: receive a configuration defining an event that triggers an event-based switch, the configuration further defining one or more of a waveform, a modulation, or a channel coding associated with the event-based switch; and perform, based at least in part on an occurrence of the event, a transmission using one or more of the waveform, the modulation, or the channel coding.

In some implementations, a network node for wireless communication includes a memory and one or more processors coupled with the memory and configured to cause the network node to: transmit a configuration defining an event that triggers an event-based switch, the configuration further defining one or more of a waveform, a modulation, or a channel coding associated with the event-based switch, and the event-based switch being associated with a transmission using one or more of the waveform, the modulation, or the channel coding.

In some implementations, a method of wireless communication performed by a UE includes receiving a configuration defining an event that triggers an event-based switch, the configuration further defining one or more of a waveform, a modulation, or a channel coding associated with the event-based switch; and performing, based at least in part on an occurrence of the event, a transmission using one or more of the waveform, the modulation, or the channel coding.

In some implementations, a method of wireless communication performed by a network node includes transmitting a configuration defining an event that triggers an event-based switch, the configuration further defining one or more of a waveform, a modulation, or a channel coding associated with the event-based switch, and the event-based switch being associated with a transmission using one or more of the waveform, the modulation, or the channel coding.

In some implementations, a non-transitory computer-readable medium storing a set of instructions for wireless communication includes one or more instructions that, when executed by one or more processors of a UE, cause the UE to: receive a configuration defining an event that triggers an event-based switch, the configuration further defining one or more of a waveform, a modulation, or a channel coding associated with the event-based switch; and perform, based at least in part on an occurrence of the event, a transmission using one or more of the waveform, the modulation, or the channel coding.

In some implementations, a non-transitory computer-readable medium storing a set of instructions for wireless communication includes one or more instructions that, when executed by one or more processors of a network node, cause the network node to: receive a configuration defining an event that triggers an event-based switch, the configuration further defining one or more of a waveform, a modulation, or a channel coding associated with the event-based switch, and the event-based switch being associated with a transmission using one or more of the waveform, the modulation, or the channel coding.

In some implementations, an apparatus for wireless communication includes means for receiving a configuration defining an event that triggers an event-based switch, the configuration further defining one or more of a waveform, a modulation, or a channel coding associated with the event-based switch; and means for performing, based at least in part on an occurrence of the event, a transmission using one or more of the waveform, the modulation, or the channel coding.

In some implementations, an apparatus for wireless communication includes means for receiving a configuration defining an event that triggers an event-based switch, the configuration further defining one or more of a waveform, a modulation, or a channel coding associated with the event-based switch, and the event-based switch being associated with a transmission using one or more of the waveform, the modulation, or the channel coding.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of backscatter communication, in accordance with the present disclosure.

FIG. 5 is a diagram illustrating an example of backscatter communication, in accordance with the present disclosure.

FIG. 6 is a diagram illustrating an example of a radio-frequency identification (RFID) tag processing session, in accordance with the present disclosure.

FIG. 7 is a diagram illustrating an example associated with a waveform and modulation configuration for transmissions, in accordance with the present disclosure.

FIGS. 8A and 8B are diagrams illustrating examples associated with a waveform and modulation configuration for transmissions, in accordance with the present disclosure.

FIGS. 9-10 are diagrams illustrating example processes associated with a waveform and modulation configuration for transmissions, in accordance with the present disclosure.

FIGS. 11-12 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

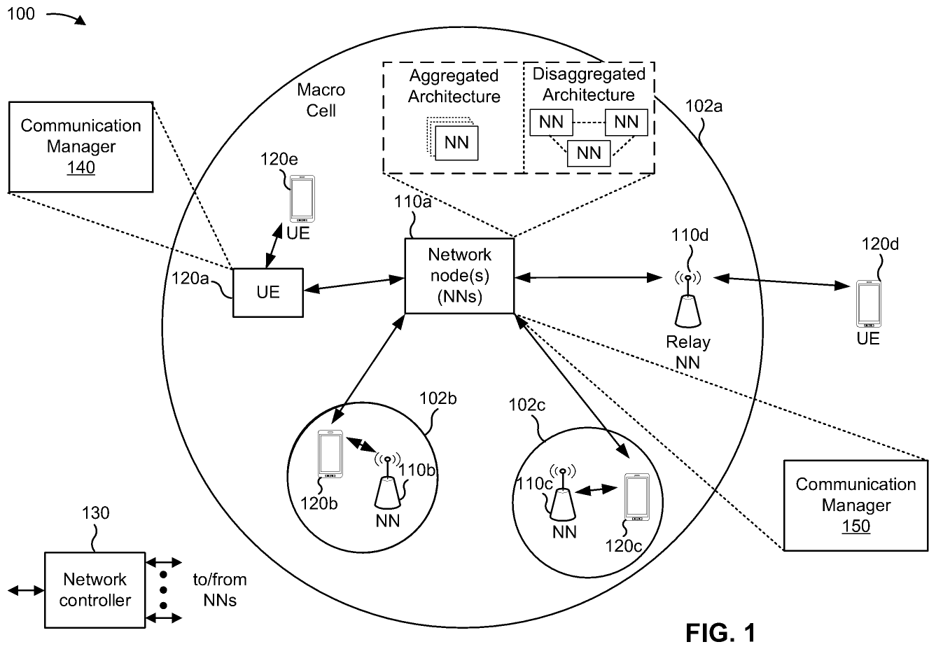

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IOT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHz-300 GHz).

Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may receive a configuration defining an event that triggers an event-based switch, the configuration further defining one or more of a waveform, a modulation, or a channel coding associated with the event-based switch; and perform, based at least in part on an occurrence of the event, a transmission using one or more of the waveform, the modulation, or the channel coding. Additionally, or alternatively, the communication manager 140 may perform one or more other operations described herein.

In some aspects, a network node (e.g., network node 110) may include a communication manager 150. As described in more detail elsewhere herein, the communication manager 150 may transmit a configuration defining an event that triggers an event-based switch, the configuration further defining one or more of a waveform, a modulation, or a channel coding associated with the event-based switch, and the event-based switch being associated with a transmission using one or more of the waveform, the modulation, or the channel coding. Additionally, or alternatively, the communication manager 150 may perform one or more other operations described herein.

As indicated above, FIG. 1 is provided as an example. Other examples may differ from what is described with regard to FIG. 1.

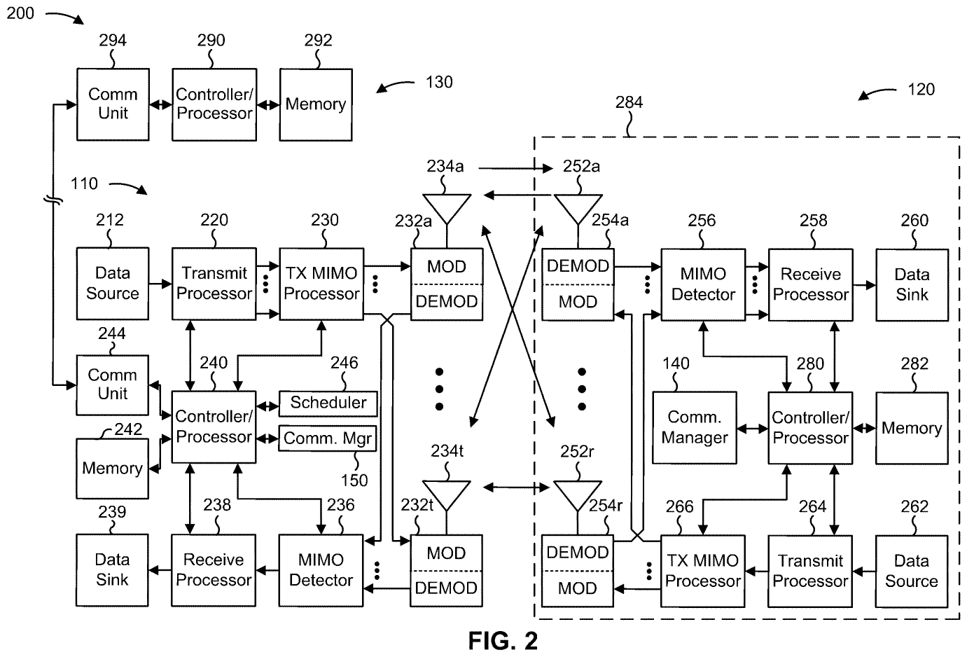

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (Tx) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

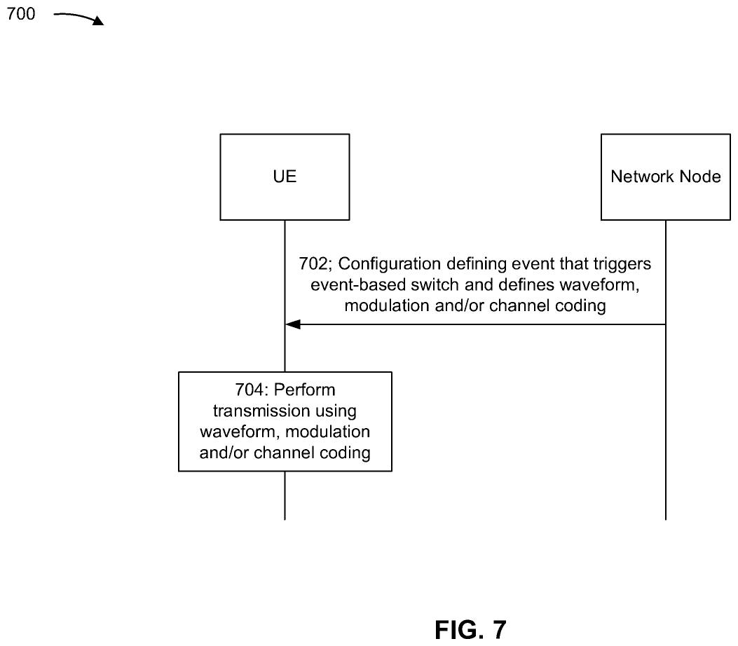

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a Tx MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the Tx MIMO processor 266. The transceiver may be used by a processor (e.g., the controller/processor 280) and the memory 282 to perform aspects of any of the methods described herein (e.g., with reference to FIGS. 7-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the Tx MIMO processor 230. The transceiver may be used by a processor (e.g., the controller/processor 240) and the memory 242 to perform aspects of any of the methods described herein (e.g., with reference to FIGS. 7-12).

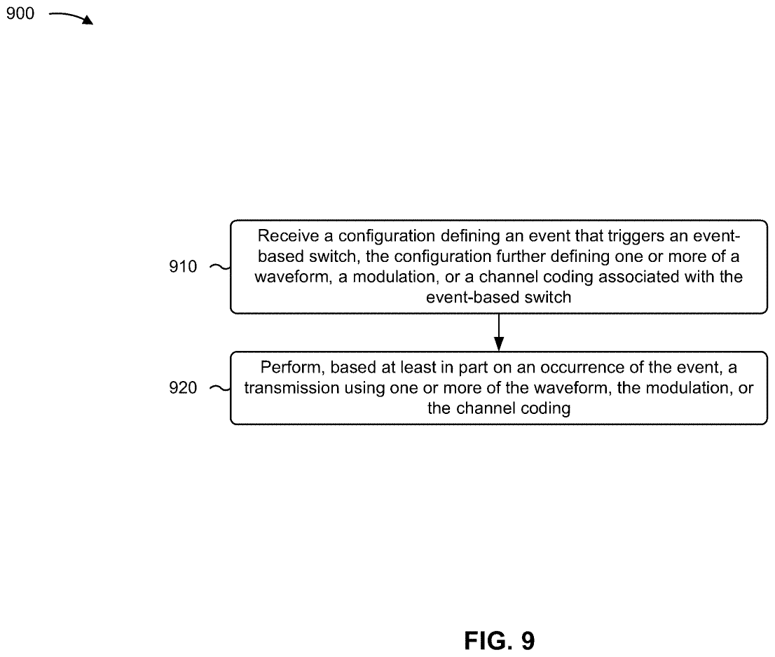

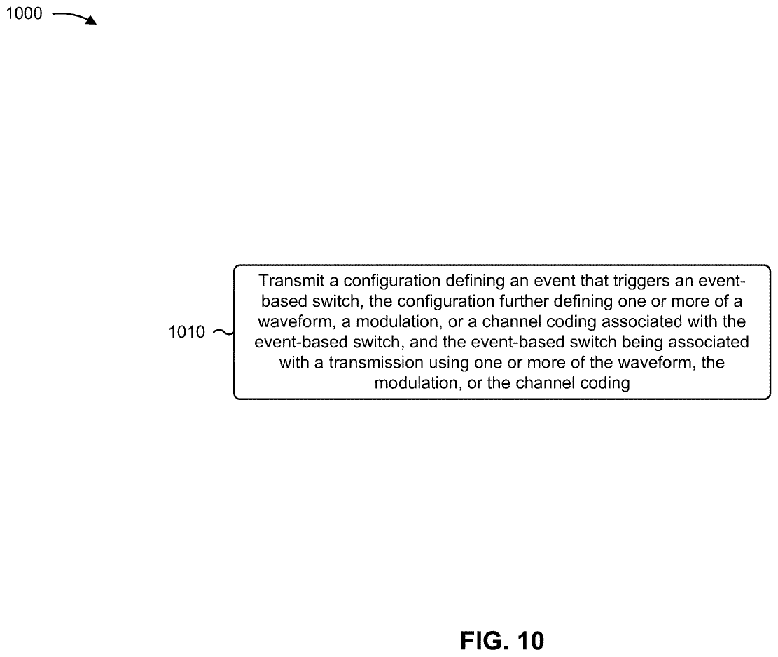

The controller/processor 240 of the network node 110, the controller/processor 280 of the UE 120, and/or any other component(s) of FIG. 2 may perform one or more techniques associated with a waveform and modulation configuration for transmissions, as described in more detail elsewhere herein. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, a UE (e.g., UE 120) includes means for receiving a configuration defining an event that triggers an event-based switch, the configuration further defining one or more of a waveform, a modulation, or a channel coding associated with the event-based switch; and/or means for performing, based at least in part on an occurrence of the event, a transmission using one or more of the waveform, the modulation, or the channel coding. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., network node 110) includes means for transmitting a configuration defining an event that triggers an event-based switch, the configuration further defining one or more of a waveform, a modulation, or a channel coding associated with the event-based switch, and the event-based switch being associated with a transmission using one or more of the waveform, the modulation, or the channel coding. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the Tx MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

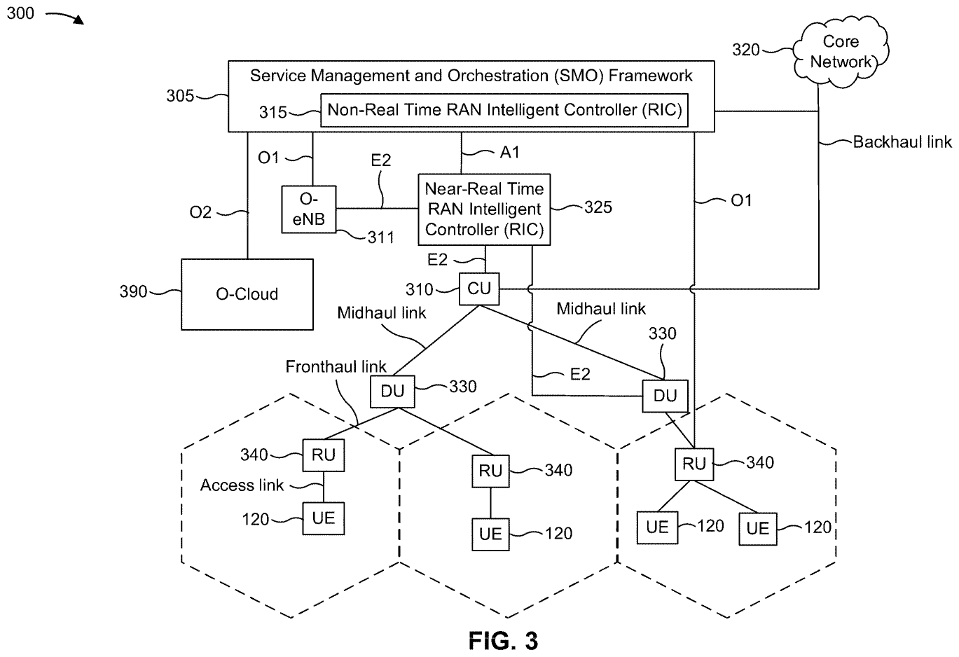

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions.

Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an Ol interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as Al interface policies).

As indicated above, FIG. 3 is provided as an example. Other examples may differ from what is described with regard to FIG. 3.

A wireless network may support energy harvesting and passive IoT. Energy harvesting may be associated with a battery-less or limited energy storage (e.g., capacitor) device. Energy harvesting may be associated with various use cases, such as power sourcing, security, access control and connectivity management, and/or positioning. Passive IoT may be associated with low tier devices, such as radio-frequency identification (RFID) devices. Passive IoT may be associated with various use cases, such as identification and/or tracking. Passive IoT may be associated with various service requirements (e.g., data rate, power, and/or density). Passive IoT may be associated with various stakeholder models, such as a public land mobile network (PLMN) or a non-public network (NPN). Passive IoT may be associated with an on-boarding, a provisioning, and/or a de-commissioning of devices. Passive IoT may be associated with various requirements regarding identification, authentication and authorization, access control, mobility management, and/or security.

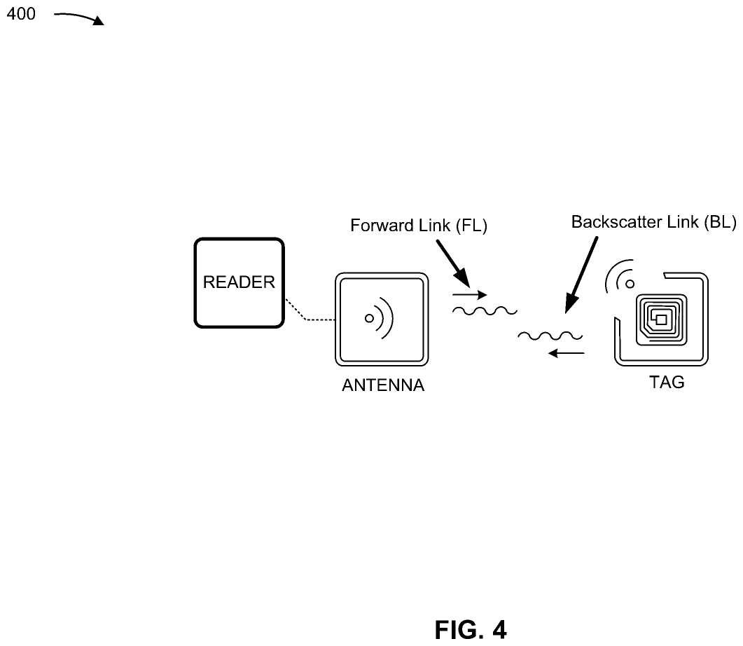

FIG. 4 is a diagram illustrating an example 400 of backscatter communication, in accordance with the present disclosure.

As shown in FIG. 4, in an ultra-high frequency (UHF) RFID system, a reader (e.g., an RFID reader) may be coupled to an antenna, and the reader may communicate with a tag (e.g., an RFID tag), which may be a passive device. The tag may include a dipole antenna and an integrated circuit (IC). The reader may transmit an RF signal via a forward link. The tag may receive the RF signal, and the received RF signal may be reflected from the tag via a backscatter link. The tag may use the received RF signal to transmit data without a battery or power source. The tag may employ a passive reflection and modulation of the received RF signal. When the tag has data to send, the tag may harvest the received RF signal to obtain power to operate. The tag may harvest (or absorb) power from the received RF signal using a rectifier, and the tag may operate using the harvested power. The rectifier may include a diode and a capacitor, and the rectifier may achieve a certain energy conversion efficiency. The tag may modulate the received RF signal to encode the data, and then the tag may reflect (or backscatter) the modulated received RF signal back to the reader in a far-field manner, thereby achieving the backscatter communication. The modulation in the tag may be based at least in part on an IC/antenna resistance match, which may provide a backscatter power, as opposed to an IC/antenna resistance mismatch, which would provide no/minimal backscatter power. A modulation efficiency may be based at least in part on a practical radiation power and an idealized radiation power. The backscatter communication may be associated with a low energy requirement and a low complexity of deployment.

The reader, or interrogator, may include a transmitter, a receiver, and a baseband processor. The antenna coupled to the reader may include a transmit antenna and a receive antenna. The reader may transmit, to the tag, an unmodulated or modulated wave (e.g., a command). The reader may transmit a continuous wave (CW), which may power up the tag. The reader may transmit modulated commands, which may include packets. The modulated commands may indicate values of 0 and 1. The tag may transmit, to the reader, a modulated wave (e.g., a response). A modulated response may include a packet. The modulated response may indicate values of 0 and 1. A reader-tag interaction may be based at least in part on a command-response model.

As indicated above, FIG. 4 is provided as an example. Other examples may differ from what is described with regard to FIG. 4.

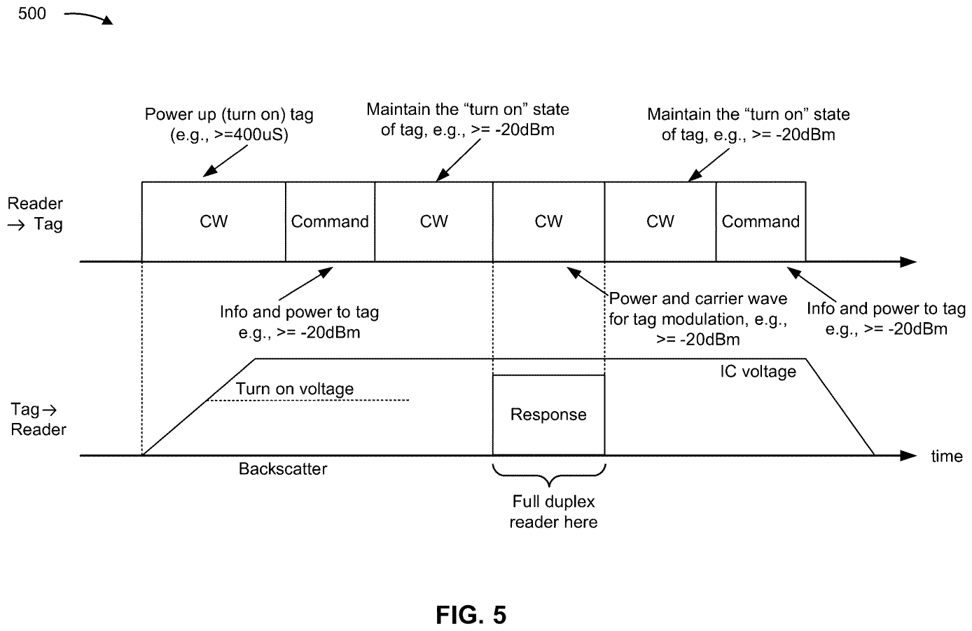

FIG. 5 is a diagram illustrating an example 500 of backscatter communication, in accordance with the present disclosure.

As shown in FIG. 5, an interrogator (reader)-talks-first (ITF) procedure may occur between a reader and a tag. The reader may transmit a first continuous wave to the tag, which may power up (or turn on) the tag. The first continuous wave may be transmitted for a duration of 400 microseconds (us) or more. The first continuous wave may cause a “turn on” voltage to be achieved at the tag. The reader may transmit a first command to the tag, which may include information and may provide power to the tag (e.g., −20 dBm or more). The reader may transmit a second continuous wave to the tag, which may maintain a “turn on” state of the tag. The reader may transmit a third continuous wave to the tag, which may provide power and a carrier wave for tag modulation. The tag may modulate and backscatter the third continuous wave, thereby providing a response to the reader. The response may include data (or a payload). The reader may transmit a fourth continuous wave to the tag, which may maintain a “turn on” state of the tag. The reader may transmit a second command to the tag, which may include information and may provide power to the tag. When the reader no longer provides continuous waves and/or commands to the reader, an IC voltage at the tag may become zero. In some cases, the first, second, third, and fourth continuous waves may not be separate waves, but rather separate pulses within the same wave.

As indicated above, FIG. 5 is provided as an example. Other examples may differ from what is described with regard to FIG. 5.

In some cases, a reader may be integrated with an RF source. In other words, the RF source and the reader may be the same device (e.g., a full-duplex device). A monostatic backscatter may involve a single antenna of the reader. The antenna may transmit a transmitted signal to a tag, and the antenna may receive a backscattered signal from the tag. Alternatively, the monostatic backscatter may involve separate antennas of the reader. A Tx antenna of the reader may transmit the transmitted signal to the tag, and a receive (Rx) antenna of the reader may receive the backscattered signal from the tag, wherein some amount of leakage may occur between the Tx antenna and the Rx antenna. In some cases, the reader and the RF source may be different devices, which may provide a half-duplex communication. A bistatic backscatter may involve a single antenna that is not co-located with the reader. The antenna may transmit a transmitted signal to a tag via a forward link, and the reader may receive a backscattered signal from the tag via a backscatter link.

An RFID tag (or backscatter device) may modulate information on a reflected signal using amplitude shift keying (ASK), which may involve the tag switching on a reflection when transmitting an information bit “1” and switching off the reflection when transmitting an information bit “0”. A reader (e.g., a first UE or a first device) may transmit a radio wave (denoted, e.g., as x(n)). Information bits of the RFID tag may be denoted by s(n)ϵ{0,1}. Then, a received signal at a second UE (e.g., a second device) may be denoted by y(n)=(h_{BU}(n)+σ_{f}h_{BD}(n)h_{DU}(n)s(n))x(n)+noise. When s(n)=0, the reflection may be switched off at the RFID tag, so the second UE only receives a direct link signal, e.g., y(n)=h_{BU}(n)x(n)+noise. When s(n)=1, the reflection may be switched on at the RFID tag, so the second UE receives a superposition of both the direct link signal and a backscatter link signal, e.g., y(n)=(h_{BU}(n)+σ_{f}h_{BD}(n)h_{DU}(n))x(n)+noise, where σ_{f} denotes a reflection coefficient.

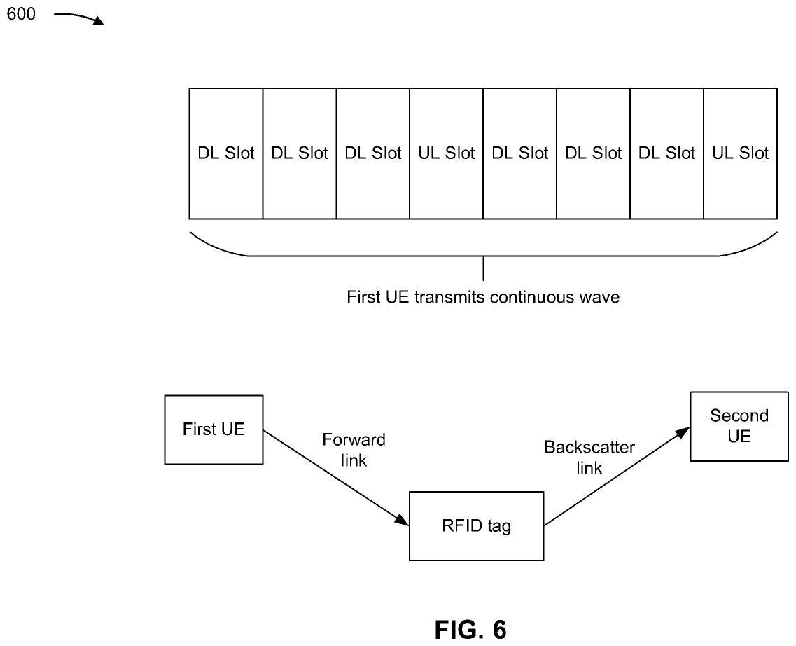

FIG. 6 is a diagram illustrating an example 600 of an RFID tag processing session, in accordance with the present disclosure.

As shown in FIG. 6, a first UE (e.g., an RF source UE) may transmit continuous waves during downlink slots and/or uplink slots to complete an RFID tag processing session. The first UE may transmit the continuous waves via a forward link. During the RFID tag processing session, an RFID tag (or backscatter device) may be read and/or configured by the first UE with an updated configuration. The updated configuration may indicate a change of parameters, a time to start a response during the RFID tag processing session, an adjusted threshold, and/or a different power/beam configuration for a next communication or for a current communication. The RFID tag may backscatter the continuous waves, which may be received by a second UE (e.g., a reader UE). In this case, the RF source UE and the reader UE may be different UEs.

The RFID tag may backscatter the continuous waves using a backscatter link.

As indicated above, FIG. 6 is provided as an example. Other examples may differ from what is described with regard to FIG. 6.

A continuous waveform may be associated with a single carrier (e.g., a single carrier), whereas an OFDM waveform may be associated with multiple carriers (e.g., multiple carriers). An OFDM/multiple carrier system may be better for RF charging, as compared to a continuous wave/single carrier system, due to the increased quantity of energy bursts, which may allow for a tuning on diodes of an energy harvesting circuit and may increase a rectifying circuit sensitivity in a low-power regime. The increased quantity of energy bursts may result in higher second and higher order (moment) statistics on received signals. The OFDM waveform may be associated with a higher RF-to-direct-current conversion efficiency in relation to an average RF input power, as compared to the continuous waveform. Thus, a relationship between an RF charging rate and a quantity of carriers may be determined when comparing the OFDM/multiple carrier system with the continuous wave/single carrier system.

An RFID tag may be a device that uses incident waves to power up an integrated circuit of the RFID tag. The RFID tag may be an energy harvesting device. A passive RFID tag may be an energy harvesting device that immediately uses harvested energy without storing the harvested energy. A semi-passive RFID tag may include a battery or energy storage unit, which may obtain energy from energy harvesting. An energy harvesting device may be a modem, a UE, a wearable device, or another type of device that harvests and stores energy in a battery or immediately uses the energy (e.g., a passive RFID tag).

Waveforms for energy harvesting devices may be associated with different purposes of energy harvesting. Such purposes may involve when an RFID tag or an energy harvesting device has a battery, a super capacitor, or an energy storage unit to store harvested energy. Such purposes may involve data only. Such purposes may involve receive data and receive energy (e.g., when an RFID tag receives commands/queries). Such purposes may involve transmit data and receive energy (e.g., when a passive RFID tag backscatters a response). An RFID tag or an energy harvesting device may not be limited to RF energy harvesting, but using waveforms for energy may relate to an underlying capability to harvest RF energy.

A type of energy harvesting waveform may have an impact on an RFID tag operation. At a same distance, when an RF source uses a single carrier (e.g., with an efficiency of 20%), an RFID tag may not be able to operate, whereas when the RF source uses multiple carriers (e.g., 8 tones, and with an efficiency of 45%), the RFID tag may be able to operate and may start receiving commands or respond (e.g., the RFID tag may backscatter its data). The type of energy harvesting waveform (e.g., single carrier versus multiple carriers) may impact whether the RFID tag is able to successfully operate, and in general, multiple carrier waveforms may be better suited for energy harvesting as compared to single carrier waveforms.

A type of data waveform may have an impact on a system performance. At a same distance, when an RF source uses a single carrier waveform versus a multiple carrier waveform, a packet error rate in relation to a path loss (in dB) may vary based at least in part on a type of channel. The type of channel may refer to a non-line-of-sight (NLOS) scenario or a line-of-sight (LOS) scenario. In the NLOS scenario, a single carrier waveform may be better (e.g., lower packet error rate) than the multiple carrier waveform at a higher path loss. In the NLOS scenario, a multiple carrier waveform may be better (e.g., lower packet error rate) than the single carrier waveform at a lower path loss. In the LOS scenario, a single carrier waveform may be better (e.g., lower packet error rate) than the multiple carrier waveform with respect to both high path loss and low path loss.

The multiple carriers may be associated with a reduced packet error rate as compared to the single carrier, based at least in part on the type of channel.

Although the type of waveform (e.g., single carrier versus multiple carriers) may have different impacts for energy harvesting and data, the type of waveform may not be considered for different tasks or scenarios. The type of waveform may not be considered for different communication ranges. The type of waveform may not be considered for energy harvesting scenarios versus communication scenarios. As a result, an operation status (e.g., whether an RFID tag is able to operate) or a packet error rate may be degraded, thereby reducing an overall system performance.

In various aspects of techniques and apparatuses described herein, a UE may receive, from a network node, a configuration that defines an event that triggers an event-based switch. The configuration may further define a waveform, a modulation, and/or a channel coding associated with the event-based switch. The event may occur based at least in part on an event change, which may be associated with a change in distance, path loss, Tx power, Rx power, charging rate, discharging rate, power level, and/or energy level. The UE may perform, based at least in part on an occurrence of the event, a transmission using one or more of the waveform, the modulation, or the channel coding. The UE, when performing the transmission, may transmit the transmission using one or more of the waveform, the modulation, or the channel coding. The transmission may be associated with assisting an RFID tag or powering an energy harvesting device (e.g., when the UE is an RF source UE or a Tx UE). The UE, when performing the transmission, may receive the transmission using one or more of the waveform, the modulation, or the channel coding (e.g., when the UE is an Rx UE or an energy harvesting device). The waveform may be a single carrier waveform or a multiple carrier waveform. The channel coding may be associated with a coding rate.

In some aspects, different waveforms (e.g., single carrier waveforms or multiple carrier waveforms) may be used for different tasks or scenarios, depending on communication ranges, and depending on energy harvesting versus communication. The different waveforms may be used based at least in part on a switching between the different waveforms. In an energy harvesting scenario, employing different waveforms based at least in part on the switching may enable some devices (e.g., RFID tags) to be operational instead of being non-operational. In a data scenario, employing different waveforms based at least in part on the switching may enable devices to achieve a lower packet error rate. As a result, an ability to switch between different waveforms, as well as between different modulations and/or channel codings, depending on a given task or scenario may improve an overall system performance.

FIG. 7 is a diagram illustrating an example 700 associated with a waveform and modulation configuration for transmissions, in accordance with the present disclosure. As shown in FIG. 7, example 700 includes communication between a UE (e.g., UE 120) and a network node (e.g., network node 110). In some aspects, the UE and the network node may be included in a wireless network, such as wireless network 100.

In some aspects, the UE may be a Tx UE. The UE may act as an RF source UE and an RF reader UE. The UE may transmit signals to an RFID tag and/or an energy harvesting device. The UE may transmit the signals for assisting the RFID tag or for powering the energy harvesting device. The UE may read signals backscattered from the RFID tag.

In some aspects, the UE may be an Rx UE. The UE may act as only an RF reader UE. The UE may read signals backscattered from the RFID tag, where an RF source UE for backscattered signals may be a separate UE. Alternatively, the UE may receive signals for energy harvesting.

As shown by reference number 702, the UE may receive, from the network node, a configuration that defines an event that triggers an event-based switch. The configuration may further define a waveform, a modulation, and/or a channel coding associated with the event-based switch. The configuration may define the event, and when the event-based switch is triggered based at least in part on an occurrence of the event, the waveform, the modulation, and/or the channel coding associated with the event-based switch may be applied. The configuration may define a plurality of different events, and for each event, a corresponding waveform, modulation, and/or channel coding may be defined. The event-based switch, which may occur based at least in part on the event, may cause the UE to switch between different waveforms, modulations, and/or channel codings. The waveform, the modulation, and/or the channel coding may dynamically change based at least in part on the occurrence of different events.

For example, the UE may initially be using a first waveform, a first modulation, and/or a first channel coding. After an occurrence of an event, which may trigger the event-based switch, the UE may start using a second waveform, a second modulation, and/or a second channel coding. The UE may receive, from the network node, the configuration that indicates the event and the second waveform, the second modulation, and/or the second channel coding that corresponds to the event.

In some aspects, the occurrence of the event may be based at least in part on an event change. The event change may be associated with a change in distance between the UE and the RFID tag, or between the UE and an energy harvesting device (e.g., a second UE). The event change may be associated with a change in pathloss between the UE and the RFID tag, or between the UE and the energy harvesting device. The event change may be associated with a change in transmit power of the UE. The event change may be associated with a change in receive power of the UE. The event change may be associated with a change in charging rate (e.g., a drop or an increase in charging rate) of the energy harvesting device. The event change may be associated with a change in discharging rate (e.g., a drop or an increase in discharging rate) of the energy harvesting device. The event change may be associated with a change in data rate in transmissions from the UE. The event change may be associated with a change in sensitivity of the RFID tag or the energy harvesting device. The event change may be associated with a change in LOS between the UE and the RFID tag, or between the UE and the energy harvesting device. The event change may be associated with a change in NLOS between the UE and the RFID tag, or between the UE and the energy harvesting device. The event change may be associated with a power state/level or an energy state/level or a battery state/level of one or more devices, which may include the UE (e.g., an RF source UE or an RF reader UE), the RFID tag, and/or the energy harvesting device. The event change may be based at least in part on a battery drop/increase in the RFID tag or the energy harvesting device.

In some aspects, the occurrence of the event may be based at least in part on a quantity of negative acknowledgements (NACKs) for command receptions (e.g., a number of or long NACKs for command receptions). The UE may receive the NACKs from the RFID tag based at least in part on commands not being successfully received by the RFID tag. The occurrence of the event may be based at least in part on a quantity of NACKs for response receptions (e.g., a number of or long NACKs for response receptions). The UE may transmit the NACKs to the RFID tag based at least in part on responses not being successfully received from the RFID tag.

In some aspects, the occurrence of the event may be based at least in part on an indication from the RFID tag. Alternatively, the indication may be from a zero-power (ZP) IoT device, a passive IoT device, a semi-passive IoT device, an ambient IoT device, an active tag, or a device with an energy harvesting capability/ability. The indication may be regarding a performance metric. The performance metric may be associated with a power requirement, a reliability requirement, a sensitivity requirement, a coverage requirement, a latency requirement, a delay requirement, a quality of service (QOS) requirement, and/or a priority requirement. The performance metric may be for a communication of commands/queries to the RFID tag. The performance metric may be for buffered data at the RFID tag, which may require communicating commands to the RFID tag to start reading information from the RFID tag. The information may be indicated by the RFID tag, or may be in the form of an indication of a changing request of a waveform, modulation, and/or channel coding. In some aspects, the occurrence of the event may be based at least in part on an indication (e.g., from an RF reader UE), where the indication may be based at least in part on a receiver sensitivity or a reliability of a reading/response quality.

In some aspects, the UE may be a first UE, and the network node may transmit the configuration to both the first UE and a second UE. The first UE may be the Tx UE and the second UE may be the Rx UE. The Rx UE may be the energy harvesting device. The configuration may be a channel state information reference signal (CSI-RS) configuration, a sounding reference signal (SRS) configuration, a physical uplink/downlink shared channel (PxSCH) configuration, or a physical uplink/downlink control channel (PxCCH) configuration. The configuration may indicate different waveforms, modulations, and/or channel codings to be used depending on different conditions, or the configuration may indicate different waveforms, modulations, and/or channel codings to be used for different tasks. After a CSI-RS resource or resource set, or an SRS resource or resource set, or other resources (e.g., resources associated with a PxSCH or a PxCCH) are triggered or scheduled, the Tx UE and the second Rx may use the corresponding waveform, modulation, and/or channel coding for transmitting a transmission. The Rx UE may use the corresponding waveform, modulation, and/or channel coding for receiving the transmission. The waveforms, modulations, and/or channel codings may dynamically change based at least in part on the occurrence of events.

In some aspects, a data waveform may depend on a distance or path loss between two entities (e.g., between two UEs, or between a UE and a network node). Energy harvesting may depend on statistics of waveforms, such that two signals with the same power may achieve different energy harvesting. Multiple carrier signals (e.g., OFDM or multiple tone signals) may achieve higher energy harvesting frequency as compared to single carrier signals (e.g., single tone signals). For simultaneous wireless information and power transfer (SWIPT) systems, for low target energy harvesting, using a Gaussian distribution may achieve a maximum data rate (for a target energy harvesting). When the target energy harvesting increases, using an on-off keying modulation may achieve a higher data rate, as compared to other types of modulation.

In some aspects, the waveform may be a first waveform associated with data only, a second waveform associated with energy harvesting, a third waveform associated with Rx data and Rx energy, or a fourth waveform associated with Tx data and Rx energy. The waveform may be a Tx data waveform or an Rx data waveform.

In some aspects, different waveforms may be used for some devices based at least in part class/type associated with the device and an indication of the different waveforms. A device may support or use a first waveform for data only, a second waveform for energy harvesting, a third waveform for (e.g., SWIPT) Rx data and Rx energy (e.g., a passive RFID tag that receives commands or queries), or a fourth waveform for Tx data and Rx energy (e.g., a passive RFID tag during backscattering). In some aspects, a device may support a Tx data waveform and/or an Rx data waveform. A device may be a Tx device that transmits waveforms for data or for energy harvesting. A device may be an Rx device that receives waveforms for data or for energy harvesting. Depending on the class/type associated with the device, different waveforms may be supported, and at a given time, a certain waveform may be used. The RFID tag may be associated with command waveforms and response waveforms. Devices, such as energy harvesting devices, may be associated with Tx waveforms and Rx waveforms.

In some aspects, the indication or the configuration to use the certain waveform may be based at least in part on signaling, such as layer 1 (L1) signaling, layer 2 (L2) signaling, or layer 3 (L3) signaling. In some cases, the class/type may be indicated initially, and then individual support for a set of waveforms, modulations, and/or channel codings for different scenarios/tasks may be signaled from time-to-time using the L1 signaling, the L2 signaling, or the L3 signaling. The signaling may be from the network node (e.g., a gNB or the controlling unit). The indication or the configuration to use the certain waveform may be between two UEs (e.g., the RF source UE and the RF reader UE), which may be based at least in part on a negotiation (including feedback) between the two UEs. The negotiation may be related to a data rate, a performance, and/or channel conditions. The negotiation may be based at least in part on the charging rate, the discharging rate, the distance, the path loss, and/or a channel state information (CSI) feedback from the RFID tag or the energy harvesting device.

In some aspects, the configuration may be a data/energy configuration. The configuration may include different configurations for the waveform, the modulation, and/or the channel coding for the data. The waveform may be a single carrier waveform or a multiple carrier waveform. The channel coding may be associated with a coding rate. The modulation may be a reference signal (RS)-based modulation, a circularly symmetric complex Gaussian (CSCG) modulation, an improper complex Gaussian modulation, an optimized sequence-based modulation, an ASK-based modulation, a phase shift keying (PSK)-based modulation, a frequency shift keying (FSK) modulation, a pulse position modulation (PPM), a pulse width modulation (PWM), a pulse amplitude modulation (PAM), a quadrature amplitude modulation (QAM), an on-off keying (OOK)-based modulation, a Zadoff Chu-based modulation, a Bernoulli sequence-based modulation, or a Manchester-based modulation.

As shown by reference number 704, the UE may perform, based at least in part on the occurrence of the event, the transmission using one or more of the waveform, the modulation, or the channel coding. The UE may detect the occurrence of the event (e.g., the UE may detect the event change), and based at least in part on the detection, the UE may perform the transmission. The UE, when performing the transmission, may transmit the transmission using the waveform, the modulation, and/or the channel coding (e.g., when the UE is the Tx UE). The transmission may be associated with assisting the RFID tag or powering the energy harvesting device. Alternatively, the UE, when performing the transmission, may receive the transmission using the waveform, the modulation, and/or the channel coding (e.g., when the UE is the Rx UE). The transmission may be associated with powering the UE (which may be the energy harvesting UE). The UE may perform the transmission, using the waveform, the modulation, and/or the channel coding, for purposes of helping the RFID tag or for purposes of energy transfer.

In some aspects, the transmission may be an SRS transmission. The transmission may be a PxSCH transmission. The transmission may be a PxCCH transmission. The transmission may be a DMRS transmission. The transmission may be a CSI-RS transmission. The transmission may be a cross-link interference (CLI) SRS transmission.

In some aspects, the UE may transmit, to the network node, capability signaling that indicates a capability of supporting the waveform, the modulation, and/or the channel coding. The capability signaling may be associated with an initial access message, a response message to a capability inquiry message, or an indication associated with L1 signaling, L2 signaling, or L3 signaling. In other words, the UE may transmit, to the network node, an indication of a capability of supporting each waveform, modulation, and/or channel coding for each task/scenario involving the RFID tag or the energy harvesting device (and from helping UEs). The UE may transmit the indication using the initial access message (e.g., a message 1 or a message 3 in a four-step random access channel (RACH) procedure, or a message A in a two-step RACH procedure). The UE may transmit the indication as the response to the capability inquiry message. The UE may transmit the indication using the L1/L2/L3 signaling over time, and based at least in part on the power requirement, the sensitivity requirement, and/or the reliability requirement at the RFID tag and at another UE (e.g., the RF reader UE). In this case, the RF reader UE may need to be able to process backscattered signals, and the RF source UE may be able to generate the signals. The L3 signaling may include user assistance information, which may be signaled via an RRC message.

In some aspects, the capability signaling may indicate the capability per band, per band combination, per component carrier, per component carrier combination, per bandwidth part (BWP), or per BWP combination for one or more devices, which may include the UE (e.g., the RF source UE or the RF reader UE) or the RFID tag.

In some aspects, the capability signaling may indicate that the UE is a passive IoT device (or passive device), a semi-passive IoT device (or semi-passive device), and/or an active IoT device (or active device). The passive IoT device may be associated with no energy storage, no signal generation, and no amplification. The semi-passive IoT device may be associated with energy storage, no signal generation, and with or without amplification, which may be associated with low-noise amplifiers (LNAs) or power amplifiers (PAS). The active IoT device may be associated with energy storage and signal generation. The UE may report a capability of being passive, semi-passive, and/or active, as a mode of operation. The UE may report the capability based at least in part on a table, where the UE may indicate one entry from the table, or the UE may report the capability using a bitmap or an individual indication. The capability may be per band, per band combination, per frequency range, per frequency range combination, per BWP, per BWP combination, per component carrier, or per component carrier combination. In some cases, the capability may change over time based at least in part on energy information, which may include a data traffic profile (e.g., an expected Rx and Tx traffic over time), a charging rate profile, a discharging rate profile, and/or an energy level profile. The UE may indicate capability changes using L1, L2, or L3 signaling, which may be based at least in part on an implementation or based at least in part on a table mapping the energy information to the capability per band, band combination, frequency range, frequency range combination, BWP, BWP combination, component carrier, or component carrier combination.

In some aspects, the capability signaling may indicate that the UE is capable of performing different energy harvesting parameters per set/bundle of resource elements (REs) or resource blocks (RBs) or BWP. For example, the capability signaling may indicate that the UE is capable of using a different power splitting factor for energy harvesting when the UE uses an energy harvesting power splitting architecture, Which may be per set/bundle of REs or RBs or BWP.

As indicated above, FIG. 7 is provided as an example. Other examples may differ from what is described with regard to FIG. 7.

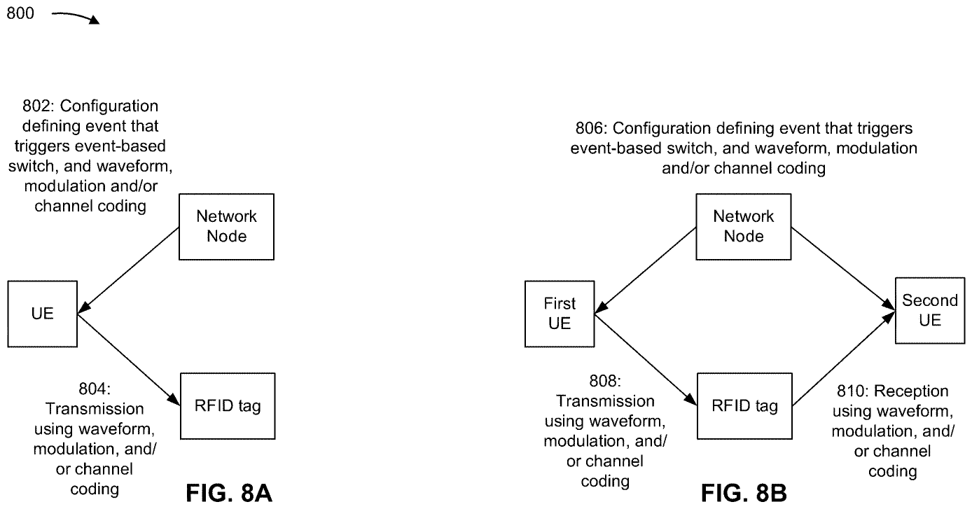

FIGS. 8A and 8B are diagrams illustrating examples 800 associated with a waveform and modulation configuration for transmissions, in accordance with the present disclosure.

As shown in FIG. 8A, in a monostatic scenario, a UE (e.g., an RF source UE and an RF reader UE) may transmit and receive signals since the UE may be capable of full duplex communications.

As shown by reference number 802, the UE may receive, from a network node (e.g., a controlling unit), a configuration defining an event that triggers an event-based switch, where the configuration further defines a waveform, a modulation, and/or a channel coding associated with the event-based switch. The network node may set the conditions for the UE. The network node may configure a transmission to be used for helping an RFID tag, or for powering an energy harvesting device, such that the waveform, the modulation, and/or the channel coding used by the UE may be based at least in part on the event-based switch.

As shown by reference number 804, the UE may perform, based at least in part on an occurrence of the event, the transmission using the waveform, the modulation, and/or the channel coding. The transmission may be an SRS transmission, a PxSCH transmission, a DMRS transmission, a PxCCH transmission, a CSI-RS transmission, a CLI SRS transmission, a new reference signal, or a new physical layer transmission. The UE may perform the transmission to the RFID tag and/or the energy harvesting device.

As shown in FIG. 8B, in a bistatic RFID tag processing, a first UE (e.g., an RF source UE) may transmit, to an RFID tag, an RF signal in the form of a continuous wave signal or a modulated continuous wave signal. The continuous wave signal may be for powering up the RFID tag, or for powering up and also piggybacking a tag response. The modulated continuous wave signal may be associated with a command.

As shown by reference number 806, a network node (e.g., a controlling unit) may transmit, to both the first UE and a second UE, a configuration defining an event that triggers an event-based switch, where the configuration further defines a waveform, a modulation, and/or a channel coding associated with the event-based switch. The network node may configure both the first UE and the second UE with the configuration.

As shown by reference number 808, the first UE may perform, based at least in part on an occurrence of the event and the configuration received from the network node, the transmission using the waveform, the modulation, and/or the channel coding. The first UE may transmit the transmission to the RFID tag and/or the second UE. The transmission may be an SRS transmission, a PxSCH transmission, a DMRS transmission, a PxCCH transmission, a CSI-RS transmission, a CLI SRS transmission, a new reference signal, or a new physical layer transmission.

As shown by reference number 810, the second UE may receive or decode the transmission using the waveform, the modulation, and/or the channel coding. The second UE may be able to receive or decode the transmission based at least in part on the configuration received from the network node. The second UE may receive the transmission directly from the first UE (e.g., when the second UE is an energy harvesting device), or the transmission may be backscattered from the RFID tag (e.g., when the second UE is an RF reader UE).

In some aspects, the first UE may be the RF source UE, and the second UE may be the RF reader UE. In a first approach, the RF source UE may collect information regarding waveforms, modulations, and/or channel codings for corresponding events. The RF source UE may collect the information in order to perform a decision (e.g., an event-based switch) based at least in part on a mapping that is shared between the RF source UE, the RF reader UE, and the network node, or based at least in part on a mapping that is predefined in a specification. In some aspects, the RF reader UE may collect the information, and then the RF reader UE may indicate the information and the decision to the RF source UE based at least in part on the mapping shared between the RF source UE, the RF reader UE, and the network node, or predefined in the specification. In this case, the decision regarding the event-based switch may be made by the RF reader UE. In some aspects, the network node may collect the information needed from the RF source UE, the RF reader UE, and/or the RFID tag, and then the network node may indicate the information and the decision to the RF source UE, the RF reader UE, and/or the RFID tag. The network node may indicate the information and the decision to the RF source UE, which may further communicate with the RF reader UE and the RFID tag. The network node may indicate the information and the decision to the RF reader UE, which may further communicate to the RF source UE and the RFID tag. In this case, the decision regarding the event-based switch may be made by the network node.

As indicated above, FIGS. 8A and 8B are provided as an example. Other examples may differ from what is described with regard to FIGS. 8A and 8B.

FIG. 9 is a diagram illustrating an example process 900 performed, for example, by a UE, in accordance with the present disclosure. Example process 900 is an example where the UE (e.g., UE 120) performs operations associated with waveform and modulation configuration for transmissions.

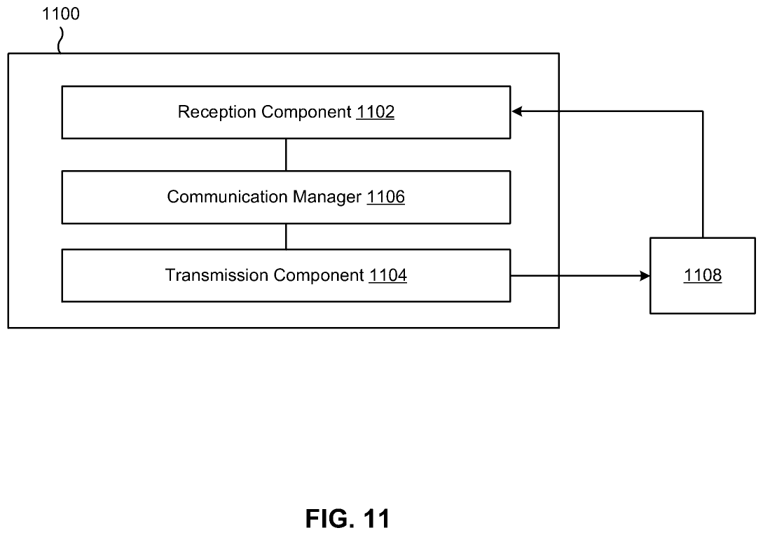

As shown in FIG. 9, in some aspects, process 900 may include receiving a configuration defining an event that triggers an event-based switch, the configuration further defining one or more of a waveform, a modulation, or a channel coding associated with the event-based switch (block 910). For example, the UE (e.g., using reception component 1102 and/or communication manager 1106, depicted in FIG. 11) may receive a configuration defining an event that triggers an event-based switch, the configuration further defining one or more of a waveform, a modulation, or a channel coding associated with the event-based switch, as described above.

As further shown in FIG. 9, in some aspects, process 900 may include performing, based at least in part on an occurrence of the event, a transmission using one or more of the waveform, the modulation, or the channel coding (block 920). For example, the UE (e.g., using communication manager 1106, depicted in FIG. 11) may perform, based at least in part on an occurrence of the event, a transmission using one or more of the waveform, the modulation, or the channel coding, as described above.

Process 900 may include additional aspects, such as any single aspect or any combination of aspects described below and/or in connection with one or more other processes described elsewhere herein.

In a first aspect, process 900 includes transmitting the transmission using one or more of the waveform, the modulation, or the channel coding, or receiving the transmission using one or more of the waveform, the modulation, or the channel coding.

In a second aspect, alone or in combination with the first aspect, the transmission is associated with assisting an RFID tag or powering an energy harvesting device.

In a third aspect, alone or in combination with one or more of the first and second aspects, the transmission is one of an SRS transmission, a PxSCH transmission, a PxCCH transmission, a DMRS transmission, a CSI-RS transmission, or a CLI SRS transmission.

In a fourth aspect, alone or in combination with one or more of the first through third aspects, the occurrence of the event is based at least in part on one or more of a change in distance, a change in pathloss, a change in transmit power, a change in receive power, a change in charging rate, a change in discharging rate, a change in data rate, a change in sensitivity, a change in line-of-sight, a change in non-line-of-sight, or a power state or an energy state or a battery state of one or more devices.

In a fifth aspect, alone or in combination with one or more of the first through fourth aspects, the occurrence of the event is based at least in part on a quantity of NACKs for command receptions, or a quantity of NACKs for response receptions.

In a sixth aspect, alone or in combination with one or more of the first through fifth aspects, the occurrence of the event is based at least in part on an indication from an RFID tag regarding a performance metric, and wherein the performance metric is associated with one or more of: a reliability, a sensitivity, a coverage, a latency, a delay, a QoS, a priority requirement for a communication of commands or queries to the RFID tag, or buffered data at the RFID tag.

In a seventh aspect, alone or in combination with one or more of the first through sixth aspects, the occurrence of the event is based at least in part on an indication, and the indication is based at least in part on a receiver sensitivity or a reliability of a reading or a response quality.

In an eighth aspect, alone or in combination with one or more of the first through seventh aspects, performing the transmission using one or more of the waveform, the modulation, or the channel coding is based at least in part a resource or a resource set being triggered or scheduled for the transmission.

In a ninth aspect, alone or in combination with one or more of the first through eighth aspects, the waveform is one of a first waveform associated with data only, a second waveform associated with energy harvesting, a third waveform associated with receive data and receive energy, or a fourth waveform associated with transmit data and receive energy.

In a tenth aspect, alone or in combination with one or more of the first through ninth aspects, the waveform is one of a transmit data waveform or a receive data waveform.

In an eleventh aspect, alone or in combination with one or more of the first through tenth aspects, the channel coding is associated with a coding rate.

In a twelfth aspect, alone or in combination with one or more of the first through eleventh aspects, process 900 includes transmitting capability signaling that indicates a capability of supporting one or more of the waveform, the modulation, or the channel coding, wherein the capability signaling is associated with one of an initial access message, a response message to a capability inquiry message, or an indication associated with L1 signaling, L2 signaling, or L3 signaling, wherein the capability is per band, per band combination, per component carrier, per component carrier combination, per BWP, or per BWP combination for one or more devices, and the capability signaling indicates that the UE is one or more of a passive IoT device, a semi-passive IoT device, or an active IoT device.

In a thirteenth aspect, alone or in combination with one or more of the first through twelfth aspects, the waveform is one of a single carrier waveform or a multiple carrier waveform.

In a fourteenth aspect, alone or in combination with one or more of the first through thirteenth aspects, the modulation is one of an RS-based modulation, a CSCG modulation, an improper complex Gaussian modulation, an optimized sequence-based modulation, an ASK-based modulation, a PSK-based modulation, a FSK modulation, a PPM, a PWM, a PAM, a QAM, an OOK-based modulation, a Zadoff Chu-based modulation, a Bernoulli sequence-based modulation, or a Manchester-based modulation.

In a fifteenth aspect, alone or in combination with one or more of the first through fourteenth aspects, the UE is an RF source UE and an RF reader UE, and the UE is configured to communicate with an RFID tag.

In a sixteenth aspect, alone or in combination with one or more of the first through fifteenth aspects, the UE is an RF source UE, another UE is an RF reader UE, and the UE is configured to communicate with an RFID tag.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network node, in accordance with the present disclosure. Example process 1000 is an example where the network node (e.g., network node 110) performs operations associated with waveform and modulation configuration for transmissions.

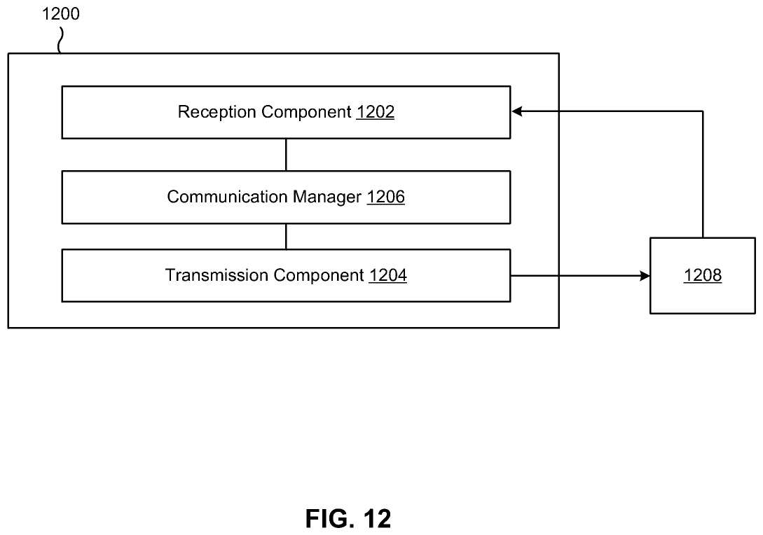

As shown in FIG. 10, in some aspects, process 1000 may include transmitting a configuration defining an event that triggers an event-based switch, the configuration further defining one or more of a waveform, a modulation, or a channel coding associated with the event-based switch, and the event-based switch being associated with a transmission using one or more of the waveform, the modulation, or the channel coding (block 1010). For example, the network node (e.g., using transmission component 1204 and/or communication manager 1206, depicted in FIG. 12) may transmit a configuration defining an event that triggers an event-based switch, the configuration further defining one or more of a waveform, a modulation, or a channel coding associated with the event-based switch, and the event-based switch being associated with a transmission using one or more of the waveform, the modulation, or the channel coding, as described above.

Process 1000 may include additional aspects, such as any single aspect or any combination of aspects described below and/or in connection with one or more other processes described elsewhere herein.

In a first aspect, the channel coding is associated with a coding rate.

In a second aspect, alone or in combination with the first aspect, process 1000 includes receiving capability signaling that indicates a capability of supporting one or more of the waveform, the modulation, or the channel coding, wherein the capability signaling is associated with one of an initial access message, a response message to a capability inquiry message, or an indication associated with L1 signaling, L2 signaling, or L3 signaling, wherein the capability is per band, per band combination, per component carrier, per component carrier combination, per BWP, or per BWP combination for one or more devices, and the capability signaling indicates that a UE is one or more of a passive IoT device, a semi-passive IoT device, or an active IoT device.

In a third aspect, alone or in combination with one or more of the first and second aspects, the waveform is one of a single carrier waveform or a multiple carrier waveform.

In a fourth aspect, alone or in combination with one or more of the first through third aspects, the modulation is one of an RS-based modulation, a CSCG modulation, an improper complex Gaussian modulation, an optimized sequence-based modulation, an ASK-based modulation, a PSK-based modulation, a FSK modulation, a PPM, a PWM, a PAM, a QAM, an OOK-based modulation, a Zadoff Chu-based modulation, a Bernoulli sequence-based modulation, or a Manchester-based modulation.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 7-8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive a configuration defining an event that triggers an event-based switch, the configuration further defining one or more of a waveform, a modulation, or a channel coding associated with the event-based switch. The communication manager 1106 may perform, based at least in part on an occurrence of the event, a transmission using one or more of the waveform, the modulation, or the channel coding. The transmission component 1104 may transmit capability signaling that indicates a capability of supporting one or more of the waveform, the modulation, or the channel coding.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 7-8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network node described in connection with FIG. 2. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, a modem, a modulator, a transmit MIMO processor, a transmit processor, a controller/processor, a memory, or a combination thereof, of the network node described in connection with FIG. 2. In some aspects, the transmission component 1204 may be co-located with the reception component 1202 in a transceiver.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit a configuration defining an event that triggers an event-based switch, the configuration further defining one or more of a waveform, a modulation, or a channel coding associated with the event-based switch, and the event-based switch being associated with a transmission using one or more of the waveform, the modulation, or the channel coding. The reception component 1202 may receive capability signaling that indicates a capability of supporting one or more of the waveform, the modulation, or the channel coding.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:
Aspect 1: A method of wireless communication performed by a user equipment (UE), comprising: receiving a configuration defining an event that triggers an event-based switch, the configuration further defining one or more of a waveform, a modulation, or a channel coding associated with the event-based switch; and performing, based at least in part on an occurrence of the event, a transmission using one or more of the waveform, the modulation, or the channel coding.
Aspect 2: The method of Aspect 1, wherein performing the transmission comprises: transmitting the transmission using one or more of the waveform, the modulation, or the channel coding; or receiving the transmission using one or more of the waveform, the modulation, or the channel coding.
Aspect 3: The method of any of Aspects 1-2, wherein the transmission is associated with assisting a radio-frequency identification (RFID) tag or powering an energy harvesting device.
Aspect 4: The method of any of Aspects 1-3, wherein the transmission is one of: a sounding reference signal (SRS) transmission, a physical uplink/downlink shared channel (PxSCH) transmission, a physical uplink/downlink control channel (PxCCH) transmission, a demodulation reference signal (DMRS) transmission, a channel state information reference signal (CSI-RS) transmission, or a cross-link interference (CLI) SRS transmission.
Aspect 5: The method of any of Aspects 1-4, wherein the occurrence of the event is based at least in part on one or more of: a change in distance, a change in pathloss, a change in transmit power, a change in receive power, a change in charging rate, a change in discharging rate, a change in data rate, a change in sensitivity, a change in line-of-sight, a change in non-line-of-sight, or a power state or an energy state or a battery state of one or more devices.
Aspect 6: The method of any of Aspects 1-5, wherein the occurrence of the event is based at least in part on: a quantity of negative acknowledgements (NACKs) for command receptions, or a quantity of NACKs for response receptions.
Aspect 7: The method of any of Aspects 1-6, wherein the occurrence of the event is based at least in part on an indication from a radio-frequency identification (RFID) tag regarding a performance metric, and wherein the performance metric is associated with one or more of: a reliability, a sensitivity, a coverage, a latency, a delay, a quality of service (QOS), a priority requirement for a communication of commands or queries to the RFID tag, or buffered data at the RFID tag.
Aspect 8: The method of any of Aspects 1-7, wherein the occurrence of the event is based at least in part on an indication, and wherein the indication is based at least in part on a receiver sensitivity or a reliability of a reading or a response quality.
Aspect 9: The method of any of Aspects 1-8, wherein performing the transmission using one or more of the waveform, the modulation, or the channel coding is based at least in part a resource or a resource set being triggered or scheduled for the transmission.
Aspect 10: The method of any of Aspects 1-9, wherein the waveform is one of: a first waveform associated with data only, a second waveform associated with energy harvesting, a third waveform associated with receive data and receive energy, or a fourth waveform associated with transmit data and receive energy.
Aspect 11: The method of any of Aspects 1-10, wherein the waveform is one of a transmit data waveform or a receive data waveform.
Aspect 12: The method of any of Aspects 1-11, wherein the channel coding is associated with a coding rate.
Aspect 13: The method of any of Aspects 1-12, further comprising: transmitting capability signaling that indicates a capability of supporting one or more of the waveform, the modulation, or the channel coding, wherein the capability signaling is associated with one of: an initial access message, a response message to a capability inquiry message, or an indication associated with layer 1 (L1) signaling, layer 2 (L2) signaling, or layer 3 (L3) signaling, wherein the capability is per band, per band combination, per component carrier, per component carrier combination, per bandwidth part (BWP), or per BWP combination for one or more devices, and wherein the capability signaling indicates that the UE is one or more of: a passive internet of things (IoT) device, a semi-passive IoT device, or an active IoT device.
Aspect 14: The method of any of Aspects 1-13, wherein the waveform is one of a single carrier waveform or a multiple carrier waveform.
Aspect 15: The method of any of Aspects 1-14, wherein the modulation is one of a reference signal (RS)-based modulation, a circularly symmetric complex Gaussian (CSCG) modulation, an improper complex Gaussian modulation, an optimized sequence-based modulation, an amplitude shift keying (ASK)-based modulation, a phase shift keying (PSK)-based modulation, a frequency shift keying (FSK) modulation, a pulse position modulation (PPM), a pulse width modulation (PWM), a pulse amplitude modulation (PAM), a quadrature amplitude modulation (QAM), an on-off keying (OOK)-based modulation, a Zadoff Chu-based modulation, a Bernoulli sequence-based modulation, or a Manchester-based modulation.
Aspect 16: The method of any of Aspects 1-15, wherein the UE is a radio frequency (RF) source UE and an RF reader UE, and wherein the UE is configured to communicate with a radio-frequency identification (RFID) tag.
Aspect 17: The method of any of Aspects 1-16, wherein the UE is a radio frequency (RF) source UE and another UE is an RF reader UE, and wherein the UE is configured to communicate with a radio-frequency identification (RFID) tag.
Aspect 18: A method of wireless communication performed by a network node, comprising: transmitting a configuration defining an event that triggers an event-based switch, the configuration further defining one or more of a waveform, a modulation, or a channel coding associated with the event-based switch, and the event-based switch being associated with a transmission using one or more of the waveform, the modulation, or the channel coding.
Aspect 19: The method of Aspect 18, wherein the channel coding is associated with a coding rate.
Aspect 20: The method of any of Aspects 18-19, further comprising: receiving capability signaling that indicates a capability of supporting one or more of the waveform, the modulation, or the channel coding, wherein the capability signaling is associated with one of: an initial access message, a response message to a capability inquiry message, or an indication associated with layer 1 (L1) signaling, layer 2 (L2) signaling, or layer 3 (L3) signaling, wherein the capability is per band, per band combination, per component carrier, per component carrier combination, per bandwidth part (BWP), or per BWP combination for one or more devices, and wherein the capability signaling indicates that a user equipment (UE) is one or more of: a passive internet of things (IOT) device, a semi-passive IoT device, or an active IoT device.
Aspect 21: The method of any of Aspects 18-20, wherein the waveform is one of a single carrier waveform or a multiple carrier waveform.
Aspect 22: The method of any of Aspects 18-21, wherein the modulation is one of a reference signal (RS)-based modulation, a circularly symmetric complex Gaussian (CSCG) modulation, an improper complex Gaussian modulation, an optimized sequence-based modulation, an amplitude shift keying (ASK)-based modulation, a phase shift keying (PSK)-based modulation, a frequency shift keying (FSK) modulation, a pulse position modulation (PPM), a pulse width modulation (PWM), a pulse amplitude modulation (PAM), a quadrature amplitude modulation (QAM), an on-off keying (OOK)-based modulation, a Zadoff Chu-based modulation, a Bernoulli sequence-based modulation, or a Manchester-based modulation.
Aspect 23: An apparatus for wireless communication at a device, comprising a processor; memory coupled with the processor; and instructions stored in the memory and executable by the processor to cause the apparatus to perform the method of one or more of Aspects 1-17.
Aspect 24: A device for wireless communication, comprising a memory and one or more processors coupled to the memory, the one or more processors configured to perform the method of one or more of Aspects 1-17.
Aspect 25: An apparatus for wireless communication, comprising at least one means for performing the method of one or more of Aspects 1-17.
Aspect 26: A non-transitory computer-readable medium storing code for wireless communication, the code comprising instructions executable by a processor to perform the method of one or more of Aspects 1-17.
Aspect 27: A non-transitory computer-readable medium storing a set of instructions for wireless communication, the set of instructions comprising one or more instructions that, when executed by one or more processors of a device, cause the device to perform the method of one or more of Aspects 1-17.
Aspect 28: An apparatus for wireless communication at a device, comprising a processor; memory coupled with the processor; and instructions stored in the memory and executable by the processor to cause the apparatus to perform the method of one or more of Aspects 18-22.
Aspect 29: A device for wireless communication, comprising a memory and one or more processors coupled to the memory, the one or more processors configured to perform the method of one or more of Aspects 18-22.
Aspect 30: An apparatus for wireless communication, comprising at least one means for performing the method of one or more of Aspects 18-22.
Aspect 31: A non-transitory computer-readable medium storing code for wireless communication, the code comprising instructions executable by a processor to perform the method of one or more of Aspects 18-22.
Aspect 32: A non-transitory computer-readable medium storing a set of instructions for wireless communication, the set of instructions comprising one or more instructions that, when executed by one or more processors of a device, cause the device to perform the method of one or more of Aspects 18-22.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a +b, a+a+c, a+b+b, a+c+c, b+b, b+b+b, b+b+c, c+c, and c+c+c, c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
memory; and
one or more processors coupled with the memory and configured to cause the UE to:
receive a configuration defining an event that triggers an event-based switch, the configuration further defining one or more of a waveform, a modulation, or a channel coding associated with the event-based switch; and
perform, based at least in part on an occurrence of the event, a transmission using one or more of the waveform, the modulation, or the channel coding.

2. The UE of claim 1, wherein the one or more processors coupled with the memory, to perform the transmission, are configured to cause the UE to:
transmit the transmission using one or more of the waveform, the modulation, or the channel coding; or
receive the transmission using one or more of the waveform, the modulation, or the channel coding.

3. The UE of claim 1, wherein the transmission is associated with assisting a radio-frequency identification (RFID) tag or powering an energy harvesting device.

4. The UE of claim 1, wherein the transmission is one of: a sounding reference signal (SRS) transmission, a physical uplink/downlink shared channel (PxSCH) transmission, a physical uplink/downlink control channel (PxCCH) transmission, a demodulation reference signal (DMRS) transmission, a channel state information reference signal (CSI-RS) transmission, or a cross-link interference (CLI) SRS transmission.

5. The UE of claim 1, wherein the occurrence of the event is based at least in part on one or more of:
a change in distance,
a change in pathloss,
a change in transmit power,
a change in receive power,
a change in charging rate,
a change in discharging rate,
a change in data rate,
a change in sensitivity,
a change in line-of-sight,
a change in non-line-of-sight, or
a power state or an energy state or a battery state of one or more devices.

6. The UE of claim 1, wherein the occurrence of the event is based at least in part on:
a quantity of negative acknowledgements (NACKs) for command receptions, or
a quantity of NACKs for response receptions.

7. The UE of claim 1, wherein the occurrence of the event is based at least in part on an indication from a radio-frequency identification (RFID) tag regarding a performance metric, and wherein the performance metric is associated with one or more of: a reliability, a sensitivity, a coverage, a latency, a delay, a quality of service (QOS), a priority requirement for a communication of commands or queries to the RFID tag, or buffered data at the RFID tag.

8. The UE of claim 1, wherein the occurrence of the event is based at least in part on an indication, and wherein the indication is based at least in part on a receiver sensitivity or a reliability of a reading or a response quality.

9. The UE of claim 1, wherein the one or more processors coupled with the memory are configured to cause the UE to:
perform the transmission using one or more of the waveform, the modulation, or the channel coding based at least in part a resource or a resource set being triggered or scheduled for the transmission.

10. The UE of claim 1, wherein the waveform is one of: a first waveform associated with data only, a second waveform associated with energy harvesting, a third waveform associated with receive data and receive energy, or a fourth waveform associated with transmit data and receive energy.

11. The UE of claim 1, wherein the waveform is one of a transmit data waveform or a receive data waveform.

12. The UE of claim 1, wherein the channel coding is associated with a coding rate.

13. The UE of claim 1, wherein the one or more processors coupled with the memory are configured to cause the UE to:
transmit capability signaling that indicates a capability of supporting one or more of the waveform, the modulation, or the channel coding,
wherein the capability signaling is associated with one of: an initial access message, a response message to a capability inquiry message, or an indication associated with layer 1 (L1) signaling, layer 2 (L2) signaling, or layer 3 (L3) signaling,
wherein the capability is per band, per band combination, per component carrier, per component carrier combination, per bandwidth part (BWP), or per BWP combination for one or more devices, and
wherein the capability signaling indicates that the UE is one or more of: a passive internet of things (IoT) device, a semi-passive IoT device, or an active IoT device.

14. The UE of claim 1, wherein the waveform is one of a single carrier waveform or a multiple carrier waveform.

15. The UE of claim 1, wherein the modulation is one of a reference signal (RS)-based modulation, a circularly symmetric complex Gaussian (CSCG) modulation, an improper complex Gaussian modulation, an optimized sequence-based modulation, an amplitude shift keying (ASK)-based modulation, a phase shift keying (PSK)-based modulation, a frequency shift keying (FSK) modulation, a pulse position modulation (PPM), a pulse width modulation (PWM), a pulse amplitude modulation (PAM), a quadrature amplitude modulation (QAM), an on-off keying (OOK)-based modulation, a Zadoff Chu-based modulation, a Bernoulli sequence-based modulation, or a Manchester-based modulation.

16. The UE of claim 1, wherein the UE is a radio frequency (RF) source UE and an RF reader UE, and wherein the UE is configured to communicate with a radio-frequency identification (RFID) tag.

17. The UE of claim 1, wherein the UE is a radio frequency (RF) source UE and another UE is an RF reader UE, and wherein the UE is configured to communicate with a radio-frequency identification (RFID) tag.

18. A network node for wireless communication, comprising:
memory; and
one or more processors coupled with the memory and configured to cause the network node to:
transmit a configuration defining an event that triggers an event-based switch, the configuration further defining one or more of a waveform, a modulation, or a channel coding associated with the event-based switch, and the event-based switch being associated with a transmission using one or more of the waveform, the modulation, or the channel coding.

19. The network node of claim 18, wherein the one or more processors coupled with the memory are configured to cause the network node to:
receive capability signaling that indicates a capability of supporting one or more of the waveform, the modulation, or the channel coding,
wherein the capability signaling is associated with one of: an initial access message, a response message to a capability inquiry message, or an indication associated with layer 1 (L1) signaling, layer 2 (L2) signaling, or layer 3 (L3) signaling, and
wherein the capability is per band, per band combination, per component carrier, per component carrier combination, per bandwidth part (BWP), or per BWP combination for one or more devices.

20. (canceled)

21. A method of wireless communication performed by a user equipment (UE), comprising:
receiving a configuration defining an event that triggers an event-based switch, the configuration further defining one or more of a waveform, a modulation, or a channel coding associated with the event-based switch; and
performing, based at least in part on an occurrence of the event, a transmission using one or more of the waveform, the modulation, or the channel coding.

22-30. (canceled)
